(19) United States
(12) Patent Application Publication
(10) Pub. No.: US 2012/0175526 A1
(43) Pub. Date: Jul. 12, 2012

(54) IONIZATION GENERATING TUBE AND AN IONIZATION GENERATING DEVICE COMPRISING THE SAME

(76) Inventors: Eun Mi Seo, Daejeon (KR); Sung Han Park, Daejeon (KR)

(21) Appl. No.: 13/498,082

(22) PCT Filed: Sep. 15, 2010
(86) PCT No.: PCT/KR2010/006300

§ 371 Date: Mar. 23, 2012

(30) Foreign Application Priority Data
Sep. 25, 2009 (KR) 10-2009-0091186

(51) Int. Cl. H01J 27/00; B28B 1/00; H01J 9/00; B28B 11/24

(52) U.S. Cl. 250/423 R; 264/5

(57) ABSTRACT

This invention relates to an ionization tube and an ionization device including the same. The ionization tube according to one aspect of this invention has a hollow structure, and the tube is formed using a mixture of a ceramic and a radioactive material, and the radioactive material is distributed along the entire length of the tube. Consequently, the ionization tube according to this invention can enhance ionization efficiency because the surface area over which alpha particles are emitted can be increased.

### CROSS-REFERENCE RELATED APPLICATIONS

This application is the National Stage Entry of International Application PCT/KR2010/006300, filed on Sep. 15, 2010, and claims priority from and the benefit of Korean Patent Application No. 10-2009-0091186, filed on Sep. 25, 2009, all of which are herein incorporated by reference for all purposes as if fully set forth herein.

### BACKGROUND

1. Field

The present invention relates to an ionization tube and an ionization device comprising the same, and particularly to an ionization tube, which is able to increase the efficiency of the ionization is of a gas that passes through the tube, and to an ionization device comprising the same.

2. Discussion of the Background

A radioactive material, for example, polonium 210 decays into stable lead (²⁰⁶Pb) while emitting alpha particles. Such alpha particles may typically move by a distance of about 3 inches in the air, and have much smaller penetrating power and considerably higher kinetic energy compared to other neutrons or beta particles. However, because such alpha particles may produce a very large amount of ions, they are widely used to remove static electricity.

Alpha particles each include two protons and two neutrons, and contain no electrons and thus are positively charged. The alpha particles which are positively charged remove electrons from a peripheral atom while passing through a material, whereby the peripheral atom is ionized.

Hence, an ionization device using the alpha particles as above is used to remove static electricity that is present on the surface of an object. Static electricity occurs due to the accumulation of electrical charges on the surface of a non-conductive material, and causes unnecessary impurities (dust, etc.) to attach themselves to the surface of camera lens or digital image sensor. Thus, when a gas which is ionized by means of an ionization device using alpha particles is supplied to the surface of an object that is electrostatic, static electricity may be removed. The ionization device using alpha particles is connected to a gas compressor or a fan in order to supply the gas to the surface of the object.

The ionization device using alpha particles may also be used to neutralize contaminated air such as the exhaust gas of automobiles. The ionization device using alpha particles is advantageous because the alpha particles collide with graphite, carbon dioxide (CO₂) and carbon monoxide (CO) particles contained in the contaminated air so that these particles are ionized and neutralized, thus exhibiting superior effects, compared to conventional smoke reduction devices used mainly to neutralize graphite using a catalyst.

The ionization device using alpha particles is provided in the form of a radioactive gun that supplies an ionized gas to a desired place. FIG. 1 is a schematic cross-sectional view showing a conventional ionization device that uses radiation.

With reference to FIG. 1, the conventional ionization device supplies high-pressure and high-speed air into a hollow cylindrical cartridge 1 via a feed line 3. The cylindrical cartridge 1 is configured such that both ends thereof are opened and an ionizing radiation source 5 is provided on the inner surface thereof The ionizing radiation source 5 is typically provided in the form of a metal foil including polonium 210 that emits alpha particles. The ionizing radiation source 5 ionizes air that passes through the cylindrical cartridge 1. The ionized air is sprayed via a nozzle 4, thereby removing static electricity.

FIG. 2 is a cross-sectional view showing the ionizing radiation source 5 of the conventional ionization device. With reference to FIG. 2, the conventional ionizing radiation source 5 is configured such that a radioactive material, for example, polonium 210, is enclosed with another metal. Accordingly, polonium 210 that is the radioactive material is positioned only on the limited portion, and thereby the conventional ionization device undesirably manifests the ionization efficiency as low as 10%.

### SUMMARY

Therefore, the present invention has been made keeping in mind the above problems occurring in the related art, and an object of the present invention is to provide an ionization tube which may exhibit high ionization efficiency, and an ionization device comprising the same.

An aspect of the present invention provides an ionization tube having a hollow structure, which is formed using a mixture comprising a ceramic and a radioactive material, wherein the radioactive material is distributed along the entire length of the tube.

Another aspect of the present invention provides an ionization tube having a hollow structure, which includes an inner surface and an outer surface, wherein a radioactive layer is formed on the inner surface and/or the outer surface of the tube along the lengthwise direction of the tube.

The ionization tube according to the present invention may include one or more among the following features. For example, the radioactive material may be the thorium series including monazite, uranium series, actinium series, or neptunium series. Also, the radioactive material may be formed via coating on at least one of the inner surface and the outer surface of the tube.

An ionization device according to an aspect of the present invention comprises the ionization tube having the above construction.

The ionization device comprises a plurality of ionization tubes, and the plurality of ionization tubes may be disposed to come into contact with each other, may be disposed to be separated from each other by a predetermined distance, or may be disposed to be nested with each other.

A method of manufacturing an ionization tube according to an aspect of the present invention comprises forming ceramic particle powder, forming a mixture of the powder and a radioactive material and stirring the mixture, molding the mixture thus forming a molded body having a tube shape, and sintering the molded body. The radioactive material may be added in an amount of 1˜60 parts by weight based on 100 parts by weight of the ceramic material.

The present invention is intended to solve the above problems, and can provide an ionization tube which exhibits high ionization efficiency and an ionization device comprising the same.

### BRIEF DESCRIPTION OF THE DRAWINGS

FIG. 1 is a cross-sectional view showing a conventional ionization device that uses radiation;

FIG. 2 is a cross-sectional view showing an ionizing radiation source of the conventional ionization device;

FIG. 3 is a perspective view showing an ionization tube according to an embodiment of the present invention;

FIG. 4 is a cross-sectional view showing an ionization tube according to another embodiment of the present invention;

FIG. 5 is a perspective view showing a plurality of ionization tubes which are disposed in circular form, according to an embodiment of the present invention;

FIG. 6 is a perspective view showing a plurality of ionization tubes which are disposed in rectangular form, according to an embodiment of the present invention;

FIG. 7 is a perspective view showing ionization tubes which are disposed to be nested with each other, according to an embodiment of the present invention;

FIG. 8 is a perspective view showing the distribution structure of ionization tubes, according to an embodiment of the present invention; and

FIG. 9 is a cross-sectional view taken along the line AA′ of FIG. 8.

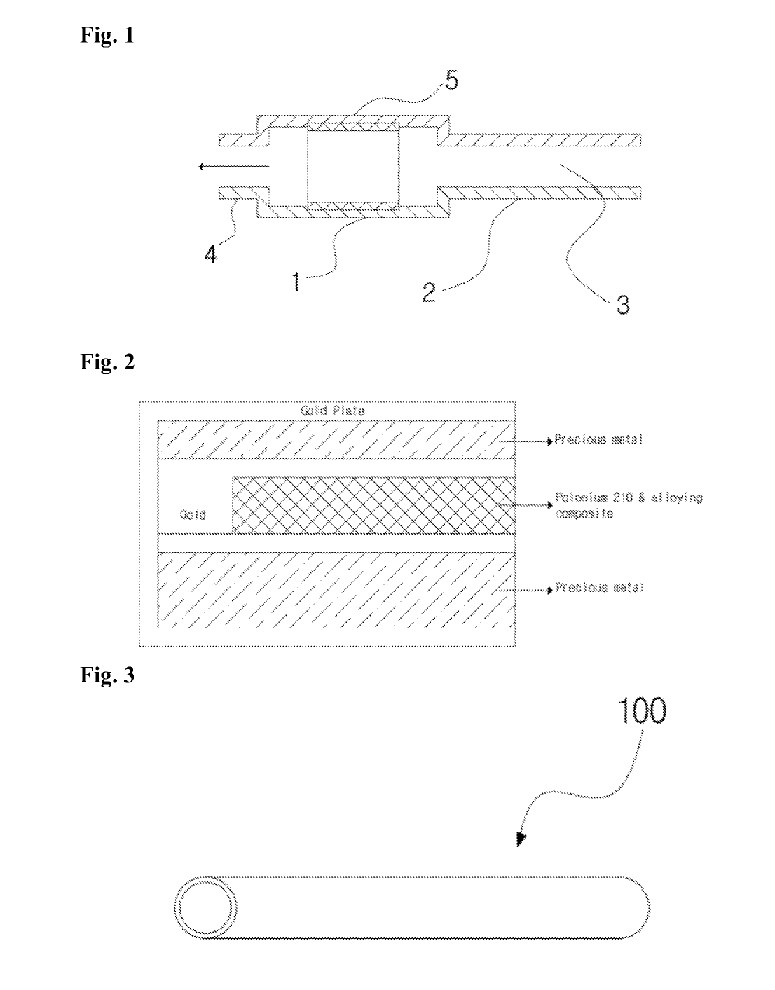

### DETAILED DESCRIPTION OF THE ILLUSTRATED EMBODIMENTS

The present invention may be variously changed and there may be a variety of examples given thereof Specific examples of the present invention are illustrated in the drawings and to are described in detail in the description. However, it will be appreciated that the present invention is not limited thereto and includes all modifications, equivalents and substitutions which are incorporated in the scope and spirit of the invention. In the description of the present invention, when it is determined that the detailed description of the related art would obscure the gist of the present invention, the description thereof will be omitted.

The terms used in this application are intended to merely describe specific embodiments and are not to be construed as limiting the invention. Unless otherwise stated, the singular includes the plural. In this application, the terms “include” or “have” or the like used herein shall be construed as indicating the presence of features, numbers, steps, operations, elements, parts or combinations thereof described in the specification, and shall be understood so as not to exclude the presence or addition of one or more other features, numbers, steps, operations, elements, parts or combinations thereof

Unless otherwise specifically defined herein, the meanings of all terms, including technical or scientific terms, are to be meanings that are understood by those skilled in the art Like terms defined in dictionaries and generally used terms need to be construed using their meaning in technical contexts and are not construed as ideal or excessively formal meanings unless otherwise clearly defined herein.

Hereinafter, preferred embodiments of the present invention will be specified with reference to the attached drawings. Throughout the accompanying drawings, the same reference numerals are used to designate the same or similar components, and redundant descriptions thereof are omitted.

FIG. 3 is a perspective view showing an ionization tube 100 according to an embodiment of the present invention, and FIG. 4 is a cross-sectional view showing an ionization tube 200 according to another embodiment of the present invention.

With reference to FIG. 3, the ionization tube 100 according to the embodiment of the present invention is provided in the form of a hollow pipe having a predetermined length and thickness. The ionization tube 100 has an inner surface and an outer surface. Furthermore, a gas such as air passes through the inside of the ionization tube 100.

The ionization tube 100 according to the present embodiment has a circular transverse cross-section, but the present invention is not limited thereto and the transverse cross-section having any shape such as an oval shape or a rectangular shape may be applied. The length and the diameter of the ionization tube 100 may be variously changed.

The ionization tube 100 according to the present embodiment may be formed using a mixture comprising a ceramic and a radioactive material. Specifically, the ceramic and the radioactive material are mixed, after which the resultant mixture is subjected to a process such as sintering or the like, thus producing a hollow ionization tube 100. In the course of mixing the ceramic and the radioactive material, the radioactive material is uniformly distributed in the entire mixture. Because such a mixture is used to produce the ionization tube 100, the radioactive material may be uniformly distributed throughout the entire tube. Thus, the radioactive material is not distributed only on a portion of the ionization tube 100 as in conventional cases, but is distributed throughout the entire tube 100, so that the contact area between the tube 100 and the gas that passes therethrough may increase, resulting in increased ionization efficiency.

The ceramic of the ionization tube 100 may include a ceramic that may operate under high temperature conditions. For example, a ceramic material may include 29.8 wt % of silica, 68.2 wt % of alumina, 0.4 wt % of ferric oxide, 1 wt % of titania, 0.1 wt % of lime, 0.1 wt % of magnesia, and 0.4 wt % of alkali. In addition, the ceramic may include the other materials such as quartz, as necessary.

The radioactive material may include monazite or thorium. Monazite is a phosphate mineral containing 30˜60% of a rare-earth metal oxide, such as cerium (Ce₂O₃), lanthanum (La₂O₃), neodyminum (Nd₂O₃) or the like, and is featured in that it may form an oxide or a nitride via a combination with oxygen or nitrogen and may react with halogen/sulfur at about 500° C. and may dissolve readily in fuming hydrochloric acid and aqua regia, as well as hydrofluoric acid. Monazite has a far infrared emissivity of 0.93 and generates negative (−) ions of 20,000˜90,000 numbers/cc upon refining. Monazite includes thorium or thorium (Th-220) having a very short half life of 55.6 sec. Also, thorium may be typically thorium 232 (Th-232).

The radioactive material may be thorium series including monazite, uranium series, actinium series, or neptunium series.

The radioactive material usable in the ionization tube 100 may include, in addition to monazite or thorium, thorite, thorianite, brannerite, cerianite, loparite, polymignite, britholite, grayite, huttonite, etc.

The ionization tube 100 is formed using the mixture comprising the milled ceramic particles and the radioactive material. The milled ceramic particles are obtained by mixing a well-refined feed, water, and an organic material such as a binder, a lubricant, etc., for a predetermined period of time, and then milling the mixture using a ball mill to create a desired particle size and particle distribution. Also, the milled ceramic is mixed with the radioactive material, after which the resultant mixture is subjected to granulation that allows it to be instantly dried using hot air so as to form granular powder. The granulation process makes it possible to form granular powder using spray drying, and spray drying is performed to instantly dry the mixed scullery using hot air, thus producing spherical powder having relatively uniform shape and size.

The ceramic powder thus obtained is mixed with the radioactive material using a stirrer thus producing the mixture of ceramic and radioactive material. The mixing proportion of the radioactive material relative to 100 parts by weight of ceramic powder is preferably 60 parts by weight or less, and should be at least 1 part by weight.

The spray dried mixture of radioactive material and ceramic is placed in a mold having the same shape as that of the ionization tube, and is then compressed, thus producing a molded body having the same shape as that of the ionization tube. The molding process may include dry pressing, cold isostatic pressing (CIP), slip casting, extrusion and injection molding. Among these, injection molding is performed in such a manner a ceramic body in a plastic state by heat passes through a die at high pressure and is molded, and extrusion is conducted by applying high pressure to ceramic powder having a plastic organic binder so that the powder is extruded via a die. Both the extrusion and the injection molding enable a circular or rectangular tube to be formed depending on the shape of the outlet of the die.

The molded body thus formed is subjected to primary processing so as to have a shape close to that of a final product, before sintering. Because the ceramic typically has high hardness and strength after sintering, it is difficult to process it after sintering. Thus, products having complicated shapes may be produced by forming portions, which have particular shapes or cannot be processed after sintering, using a variety of machine tools such as lathes or milling machines, before sintering. The ionization tube 100 having a circular shape may be processed using lathing, and the ionization tube 100 having a rectangular shape or a complicated shape may be processed using a milling machine or computer numerical control (CNC) lathes. As such, the molded body itself is in a state of compacted powder and thus should be handled so as to prevent cracking and deterioration of the properties due to processing stress upon sintering with care being taken not to crack or chip.

After primary processing, the molded body is sintered at a high temperature of 1600° C. or more, so that the mixed organic material is decomposed and pores between the particles are removed thus making the tissue dense and growing the particles. The sintering process may include normal sintering, hot pressing, hot isostatic pressing, reaction sintering, etc. The normal sintering is performed without applying external pressure to the molded body, and in order to easily and precisely perform sintering, a feed having a small particle diameter may be used and a large amount of sintering additive may be added. The hot pressing process is performed to obtain high density using a very small amount of sintering additive under pressure, and a denser structure may be formed, compared to normal sintering. Also, the hot-isostatic pressing process simultaneously performs isostatic pressing and sintering to supplement defects of the hot pressing, wherein feed powder is placed in a capsule formed of iron, molybdenum, platinum, etc., and then heated while being isostatically pressed from the outside using a pressure medium comprising an inert gas such as argon (Ar), nitrogen (N₂), helium (He), etc. The reaction sintering process carries out sintering while causing a chemical reaction.

After sintering, grinding or surface processing may be carried out using diamond or the like to obtain precise products and a superior surface.

The gas introduced into the ionization tube 100 thus manufactured may be a gas such as air, argon or nitrogen. The gas introduced into the ionization tube 100 is ionized by the alpha particles that are emitted from the radioactive material contained in the ionization tube 100.

Although the ionization tube 100 as illustrated has a predetermined diameter, the diameter thereof may vary along the longitudinal direction depending on the conditions of the device where the ionization tube is installed. For example, in order to increase the rate at which the gas is sprayed via the ionization tube 100, the diameter of the outlet of the ionization tube 100 may be formed to be smaller than the inlet thereof.

FIG. 4 is a cross-sectional view showing an ionization tube 200 according to another embodiment of the present invention.

With reference to FIG. 4, the ionization tube 200 according to another embodiment of the present invention includes a radioactive layer 220 comprising a radioactive material formed on each of the inner surface and the outer surface thereof. The radioactive layer 220 may be formed by applying the radioactive material or by providing the radioactive material in the form of a metal foil and then attaching it to the inner surface and the outer surface of the tube. The ionization tube 200 according to the present embodiment has the radioactive layer 220 formed on each of the outer surface and the inner surface thereof, so that the gas that passes through the inside and the outside of the tube 200 may be ionized.

In the present embodiment, the radioactive layer 220 is formed on both the inner surface and the outer surface of the ionization tube 200, but the radioactive layer 220 may be formed on either the inner surface or the outer surface, as necessary.

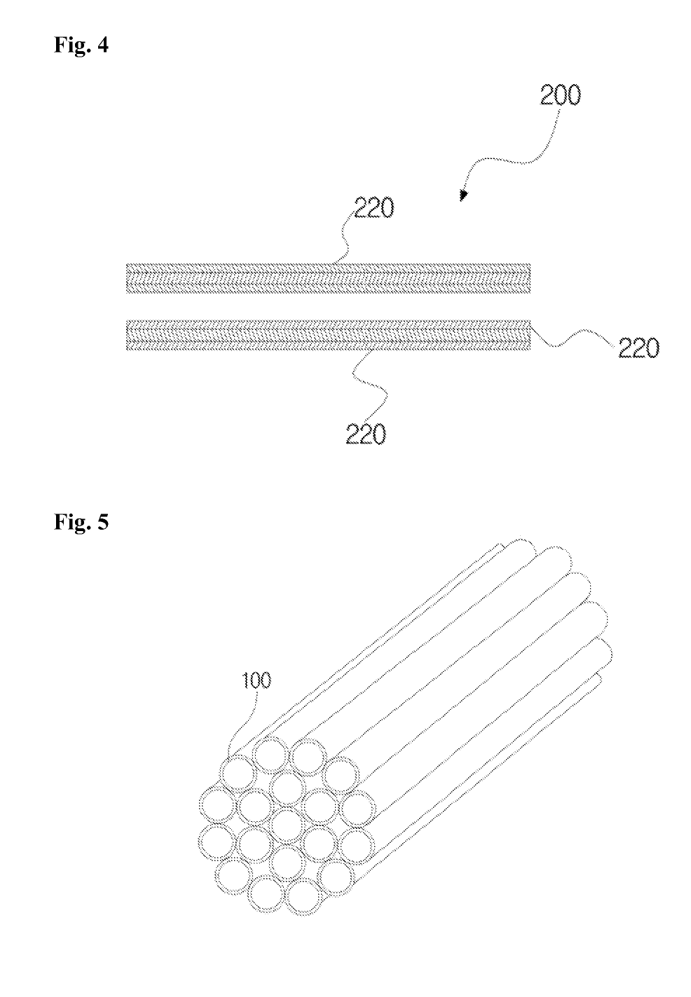

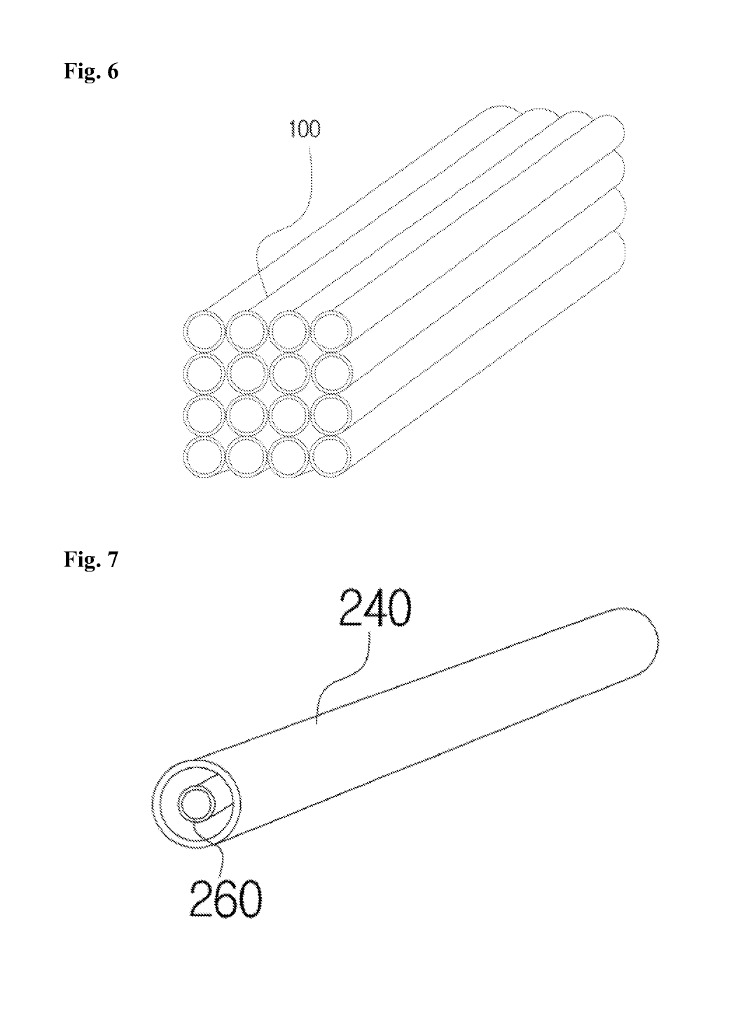

FIG. 5 is a perspective view showing a plurality of ionization tubes 100 which are disposed in circular form, and FIG. 6 is a perspective view showing a plurality of ionization tubes 100 which are disposed in rectangular form.

The plurality of ionization tubes 100 may be disposed in circular form as shown in FIG. 5 or in rectangular form as shown in FIG. 6, depending on the properties of the ionization device. In order to dispose the tubes in various forms, the plurality of ionization tubes 100 may be bound so as to come into contact with each other and then cut in a longitudinal direction so as to be imparted with a desired cross-sectional shape. The case of FIG. 5 corresponds to the bundle of ionization tubes 100 which are cut in circular form, and the case of FIG. 6 corresponds to the bundle of ionization tubes 100 which are cut in rectangular form.

In this way, the plurality of ionization tubes 100 which are disposed to come into contact with each other may increase the contact area with the gas that passes therethrough, advantageously enhancing the ionization efficiency.

FIG. 7 illustrates ionization tubes 100 which are disposed to be nested with each other.

With reference to FIG. 7, an ionization tube 260 having a small diameter is received in an ionization tube 240 having a large diameter. Thus, the gas that passes through the inside of the ionization tube 240 having a large diameter is ionized while coming into contact with the inner surface and the outer surface of the ionization tube 260 having a small diameter. In the case where the ionization tubes having different diameters are disposed to be nested with each other as illustrated in FIG. 7, they may be configured such that alpha particles are emitted via the inner surface of the ionization tube 240 having a large diameter and the inner and outer surfaces of the ionization tube 260 having a small diameter.

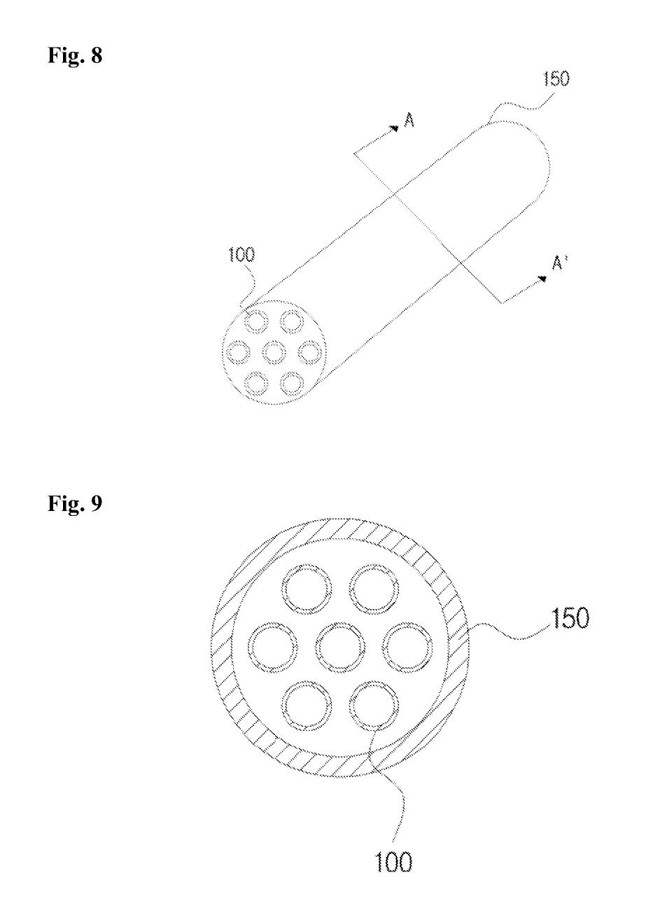

Also, as shown in FIGS. 8 and 9, a plurality of ionization tubes 100 may be disposed so as to be spaced apart from each other by a predetermined distance. FIG. 8 is a perspective view is showing another disposition structure of the plurality of ionization tubes 100, and FIG. 9 is a cross-sectional view showing the ionization tubes 100.

With reference to FIGS. 8 and 9, the plurality of ionization tubes 100 having the same length and diameter are disposed by a predetermined distance from each other. Such ionization tubes 100 are accommodated in a cylinder 150. Thus, the gas that passes through the cylinder 150 is ionized by the emitted alpha particles while coming into contact with the inner and outer surfaces of the ionization tubes 100. Also, the radioactive material may be formed on the inner surface of the cylinder 150 so as to emit alpha particles.

When the plurality of ionization tubes 100 is positioned to be spaced apart from each other without being in contact in this way, the contact area between the gas and the ionization tubes 100 may increase, ultimately enhancing the ionization efficiency.

The plurality of ionization tubes 100 illustrated in FIGS. 5 to 8 is connected to an air compressor (not shown) or a fan (not shown) of the ionization device so as to receive the gas. Also, the plurality of ionization tubes 100 is connected to a spray gun or a blower and thus may be sprayed onto the surface of an object.

The ionization device comprising the ionization tube 100, 200 may be utilized to remove impurities such as dust and so on from semiconductor wafers, etc., or may be used as a smoke reduction device of automobiles, etc.

Although the embodiments of the present invention have been disclosed for illustrative purposes, those skilled in the art will appreciate that various modifications and substitutions are possible, without departing from the scope and spirit of the invention.

1. An ionization tube having a hollow structure, the ionization tube comprising a mixture comprising a ceramic and a radioactive material, wherein the radioactive material is distributed on a surface of the ionization tube and comprises at least one selected from among uranium series, actinium series, neptunium series, and thorium series, the thorium series comprising monazite.

2. An ionization tube having a hollow structure, the ionization tube comprising an inner surface and an outer surface, wherein a radioactive layer is disposed on the inner surface and/or the outer surface along a lengthwise direction of the ionization tube and comprises at least one radioactive material selected from among uranium series, actinium series, neptunium series, and thorium series, the thorium series comprising monazite.

3. An ionization tube having a hollow structure, the ionization tube comprising a sintered mixture comprising a ceramic and a radioactive material, wherein the radioactive material is distributed along an entire length of the ionization tube and comprises monazite, the monazite comprising a rare-earth metal oxide and at least one of thorium 220 (Th-220) and thorium 232 (Th-232).

4. The ionization tube of claim 2, wherein the radioactive material is disposed on at least one of the inner surface and the outer surface of the ionization tube.

5. An ionization device, comprising a plurality of ionization tubes having a hollow structure, wherein the plurality of ionization tubes are bundled, the plurality of ionization tubes comprising inner surfaces and outer surfaces, and wherein a radioactive layer is disposed on the inner surfaces or the outer surfaces of the ionization tubes along a lengthwise direction of the ionization tubes, the radioactive layer comprising at least one radioactive material selected from among uranium series, actinium series, neptunium series, and thorium series, the thorium series comprising monazite.

6. The ionization device of claim 5, wherein the plurality of ionization tubes are connected with each other.

7. The ionization device of claim 5, wherein the plurality of ionization tubes are separated from each other.

8. The ionization device of claim 5, wherein first ionization tubes are disposed in hollows of the plurality of ionization tubes.

9. A method of manufacturing an ionization tube, comprising:
forming a ceramic particle powder;
mixing the ceramic particle powder and a radioactive material to generate a mixture;
molding the mixture to form a molded body having a tube shape; and
sintering the molded body.

10. The method of claim 9, wherein the radioactive material is added in an amount in a range of about 1 to about 60 parts by weight based on 100 parts by weight of the ceramic material.

11. The method of claim 9, wherein the forming the ceramic particle powder comprises:
milling ceramic particles; and
forming a mixture of milled ceramic particles and the radioactive material, and performing granulation to dry the mixture using hot air to generate granular powder.

12. The method of claim 11, wherein, between the forming of the molded body and the sintering, a processing is performed to change a shape of the molded body.

13. The method of claim 9, wherein the radioactive material comprises monazite, the monazite comprising a rare-earth metal oxide and at least one of thorium 220 (Th-220) and thorium 232 (Th-232).
